(19) United States
(12) Patent Application Publication
(10) Pub. No.: US 2014/0263033 A1
(43) Pub. Date: Sep. 18, 2014

(54) Process For Forming A Three-Dimensional Non-Woven Structure

(71) Applicant: 2266170 Ontario Inc., Mississauga (CA)

(72) Inventors: YuCheng Fu, Guelph (CA); Liberatore A. Trombetta, Ancaster (CA)

(21) Appl. No.: 14/205,816

(22) Filed: Mar. 12, 2014

Related U.S. Application Data
(60) Provisional application No. 61/778,860, filed on Mar. 13, 2013.

(51) Int. Cl. A47J 31/06; B29C 51/00; D04H 13/00

(52) U.S. Cl. CPC A47J 31/06; D04H 13/00; B29C 51/004
USPC 210/500.1; 442/327; 442/401; 428/196; 428/36.1; 264/324

(57) ABSTRACT

A process is disclosed for forming a three-dimensional structure from a nonwoven web. The web is made of synthetic polymer filaments. The process comprises subjecting the web to a molding force at a temperature between the glass transition temperature and the melting temperature of the polymer. The nonwoven web is constructed so as to allow ample elongation of the constituent filaments. The web is preferentially bonded in selected areas. The filaments are only partially drawn during the spinning process, so as to preserve elongation potential. The three-dimensional structures made by the process can be shaped filters, for example for use in beverage capsules.

### BACKGROUND OF THE INVENTION

1. Field of the Invention

The invention relates generally to a process for forming a three-dimensional non-woven structure, and more particularly to a process for forming a three-dimensional filter element.

2. Description of the Related Art

Many processes involving filtration use paper as the filtration medium. Paper offers many advantages. Paper making processes have a long history, and the parameters that determine the mechanical properties of paper are well understood. Paper filters are used extensively in processes such as air filtration and food preparation, in particular brewing beverages such as coffee or tea.

Use of paper as a filtration medium has a number of disadvantages. Paper is not amenable to molding into a three-dimensional shape by stretching the fibers. If a three-dimensional shape is required, resort is being had to folding or pleating, for example, sometimes combined with the creation of one or more glue lines to preserve the desired shape.

Another disadvantage of paper filters is that the strength of a paper web is significantly weakened when the paper fibers are wetted with water. For many applications this creates a need for supporting the paper filter with a rigid structure, such as a funnel. These rigid structures negatively impact the flow of liquid through the filter, and increase the cost.

Small paper filters can be used with aqueous liquids without providing a rigid support structure, as for example in certain single-serve coffee and tea capsules. However, these filters tend to sag against the side walls of the capsule when wet, which limits the flow of the aqueous liquid through the filter. It has been proposed to provide pleats in the side walls of such filters, so as to limit the contact area with the side walls of the capsule. The pleating step adds complexity to the manufacturing process. Moreover, it has been found that the pleats are not sufficiently dimensionally stable in use, in particular when larger amounts of ground roast coffee and/or extended brewing times are employed.

Another significant disadvantage of paper filters, which has recently been discovered by the present inventors, is that paper fibers absorb valuable flavor components from brewed beverages. Moreover, paper fibers swell when they get wet, which reduces the pore size of a paper filter during brewing and reduces the delivery of flavor components to the consumer's beverage. Nonwoven webs are used as filter elements in a variety of applications, typically in the form of flat sheets. Such sheets lack sufficient structural integrity, and need to be supported by a frame. Glass fibers are commonly used in filter elements; synthetic polymer fibers are also used. Such filter elements are generally manufactured by techniques in which fibers are randomly deposited onto a foraminous support, for example wet laying or air laying. The pore size distribution of the filter material is largely determined by the fiber diameter and by the basis weight of the filter element.

Prior art nonwoven filters are not suitable for forming three-dimensional structures with adequate filtration and shape retention properties. In general such filters lack the elongation properties to allow a deep draw, and the mechanical strength to retain the desired three-dimensional shape. Moreover, such nonwoven filters lack the mechanical integrity to allow control of the pore size distribution during the shaping process.

Thus, there is a particular need for a process for forming a three-dimensional filter structure from a nonwoven web that results in a structure that retains the desired shape, and that allows control of the pore size distribution of the resulting structure.

### BRIEF SUMMARY OF THE INVENTION

The present invention addresses these problems by providing a process for forming a three-dimensional structure from a non-woven synthetic polymer filament web, said synthetic polymer having a glass temperature T_{g} and a melt temperature Tₘ, said process comprising the steps of:

providing a non-woven web of synthetic polymer filaments having a web area and a bonding area such that the bonding area is from 2% to 50% of the web area; and a web tensile strength in the range of 5 to 120 N/cm;

subjecting the non-woven web to a molding force at a temperature T_{d}, such that T_{g}<T_{d}<Tₘ to form a three-dimensional structure;

cooling the three-dimensional structure to ambient temperature.

Another aspect of the invention comprises a nonwoven web for use in the process of the invention.

Another aspect of the invention comprises a three-dimensional structure formed by the process of the invention.

### BRIEF DESCRIPTION OF THE DRAWINGS

The features and advantages of the invention will be appreciated upon reference to the following drawings, in which:

FIGS. 1A-1D are schematic illustrations of the molding process; and

FIGS. 2A-2F show a number of examples of bonding patterns.

### DETAILED DESCRIPTION OF THE INVENTION

The following is a detailed description of the invention.

### Definitions

The term “melt index” as used herein refers to a common measurement used to characterize thermoplastic polymers. It is essentially an indirect, and inversely proportional, measure of the viscosity of the polymer when molten. One measures the mass of polymer melt which will flow through an orifice in a given amount of time under defined conditions of temperature, pressure, and geometry. The larger the melt index value, the lower is its viscosity, and therefore, the average molecular weight of the polymer is lower (although other factors, such as processing and additives, also play a role). Higher molecular weight polymers will generally be more viscous and less will flow under the same conditions so the melt index will be a smaller number. The melt index is typically expressed in terms of grams of polymer which flow out in a ten minute period, thus g/10 min or dg/min.

Different polymer types often report melt index at differing conditions. For example, polyethylenes typically report melt index at 190° C. whereas polypropylenes are typically reported at 230° C., due in part to their differing melting points. Therefore, melt index values are not always directly comparable between polymer types.

There are standardized methods for melt index under ASTM and ISO, for example, ASTM D1238. Such standard methods specify the geometry and other constraints on the device used as well as the combinations of conditions. The device is essentially an upright, narrow cylindrical barrel fitted with a plunger and a removable (for cleaning) orifice at the bottom. The barrel is temperature controlled and a defined weight is placed on the plunger to provide the prescribed force and thus pressure on the plunger, which drives the polymer melt through the orifice. Typically, polymer pellets are loaded into the barrel and allowed to come to the measurement temperature, well above the polymer melting point. Then the weight is applied to the plunger, forcing polymer through the orifice. The extrudate is measured by weighing, or by volumetric methods (plunger travel) using known melt density.

Different weights may be used on the plunger for different polymer types or for different molecular weight ranges within products of a given type. For example, blow molding grades of HDPE might report a melt index value using a 21.6 kg weight, due to the high viscosity of such grades, while blown film extrusion grades of LLDPE or LDPE generally use a 2.16 kg weight.

Terminology also varies among polymer types and can be a source of confusion. Melt index, melt flow index, and melt flow rate are generally synonymous but often connote different measurement conditions and are frequently associated with different polymer types. Ratios of melt flows measured using two different weight loadings are also sometimes used to characterize the degree of shear-thinning behavior of the polymer. As the force increases, the apparent viscosity decreases and the flow is higher than expected, thus the melt flow ratio can differ between two polymers when expressed as the ratio of melt index measured at high loading to that at low load for each polymer. Changes in melt flow ratios usually reflect differences in molecular weight distribution and/or levels of long chain branching between polymer grades.

The term “low shrink” as used herein refers to the propensity of synthetic polymer filaments to shrink in length when subjected to elevated temperatures. As will be explained in more detail below, the process of the invention comprises subjecting a nonwoven web to a molding force at elevated temperature. Although some shrinkage of the filaments in the web during this molding step is acceptable, and generally unavoidable, excessive shrinkage should be avoided. The nonwoven web is considered low shrink if the molding process causes less than 20% shrinkage, preferably less than 10%, more preferably less than 5%.

The term “underdrawn filament” as used herein refers to the practice of stretching or “drawing” a polymer filament during the spinning process. Stretching of a freshly spun filament followed by quenching results in alignment of polymer molecules within the filament, and, depending on the nature of the polymer, a degree of crystallization. This is desirable for most common uses of the polymer filament, which generally do not involve subjecting the filament to elevated temperatures. For the process of the present invention, however, in which the filaments are subjected to elevated temperatures during the molding step, high degrees of alignment and/or crystallization are undesirable, as they reduce the ability of the filaments to elongate during the molding step.

Some stretching of the filaments during the spinning process is acceptable, and even desirable. The stretching should, however be significantly less than would commonly be used for the polymer in question, resulting in a degree of alignment and/or crystallization that is significantly less than the maximum that can be obtained by drawing the filament. The resulting filament is referred to herein as “underdrawn.”

In its broadest aspect the present invention relates to a process for forming a three-dimensional structure from a non-woven synthetic polymer filament web, said synthetic polymer having a glass temperature T_{g} and a melt temperature Tₘ, said process comprising the steps of:

providing a non-woven web of synthetic polymer filaments having a web area and a bonding area such that the bonding area is from 2% to 50% of the web area; and a web tensile strength in the range of 5 to 120 N/cm;

subjecting the non-woven web to a molding force at a temperature T_{d}, such that T_{g}<T_{d}<Tₘ to form a three-dimensional structure;

cooling the three-dimensional structure to ambient temperature.

The main advantages of this process are a good control of the porosity of the resulting structure, as determined by air permeability measurements, and good shape retention of the three-dimensional structure.

Selection of the resin for the synthetic polymer filaments is important for successful application of the process. The synthetic polymer must be a thermoplastic polymer, that is, a polymer having a glass temperature T_{g} and a melt temperature Tₘ such that Tₘ>T_{g}. Examples of suitable resins include polyolefins, in particular polyethylene and polypropylene; polyesters, in particular polyethylene terephtalate (PET) and polybutylene terephtalate; polyamides, in particular of the Nylon family of polymers, such as Nylon 6 and Nylon 6,6; and combinations thereof.

A resin should be selected that has good nonwoven manufacturing properties and that can be converted into a fabric having good molding properties. Within a class of polymers the processing properties of a resin generally depend on the molecular weight; the degree of polymerization; the moisture level; and the melt flow index.

No specific ranges of molecular weight and degree of polymerization are prescribed for the resins to be used in the process of the invention. Rather, the degree of polymerization should be such as to yield a resin that is melt-spinnable, and a melt flow index that is high enough for good melt-spinning behavior without causing blockage etc.

The moisture level is important, as moisture present in the resin can cause polymer degradation and molecular chain breakage during the spinning process. The amount of moisture that can be acceptable depends in part on the desired spinning behavior and the physical properties of the polymer, such as hydrophilicity. Generally the moisture level should be below 500 ppm by weight, preferably below 300 ppm by weight, more preferably below 200 ppm by weight.

As explained above, low shrinkage is an important attribute of the resin for use in the process of the invention. Polyesters, such as PET, are characterized by a relatively high thermal instability, that is, these polymers tend to shrink when exposed to elevated temperatures. This property makes these resins less suitable for use in the process of the invention, but these resins can be stabilized by subjecting them to a heat-set process. Heat-set polyesters generally are suitable for use in the process of the invention. The heat-set step is generally carried out after the web is formed, and provides bonding at the same time.

The polymer filaments can be monocomponent, or comprise more than one component. Examples of the latter include sheath-core filaments, islands-in-the-sea structures, segment (hollow) pie, side by side and the like.

During the spinning process the spinning speed (expressed as grams per hole per minute (“GHM”)) and hot drawing ratio need to be controlled to produce underdrawn filaments. Underdrawn filaments are characterized by having a large breaking elongation at the molding temperature T_{d}, which is important for the molding potential of the fabric. The drawing ratio needs to be controlled to keep polymer chain orientation and crystallization within acceptable limits, so as to preserve the elongation properties of the filaments. Normally underdrawn fibers show low birefringence value (a measure of molecular anisotropy) and low elastic modulus.

The nonwoven web desirably has a degree of bonding such that the web has a tensile strength in the range of from 5 to 120 N/cm, preferably from 10 to 100 N/cm. In a melt-blown process filaments, freshly formed by blowing the melted polymer, are collected on a collection belt, which results in a degree of spontaneous bonding. In a spun-bond process a separate bonding step is carried out after the web is laid.

The use of excessive heat during the bonding step should be avoided, as the use of heat significantly reduces the elongation properties of the filaments by increased crystallinity. Poor elongation properties of the filaments cause disruption of the filament network during the molding step, and poor forming depth.

Certain bonding processes do not use heat. Examples include hydroentanglement, which uses highly pressurized water to interlock the filaments.

Other bonding processes apply heat only in localized areas of the web. An example is superficial bonding (“s-wrap”), in which only filaments at a surface of the web are heat treated. Another example is ultrasonic bonding, in which localized areas are subjected to ultrasound energy, so that a pattern of bonding areas is created.

When localized bonding is employed, the bonding area generally is from 2% to 50% of the web area, preferably from 2% to 30%, more preferably from 3% to 15%.

The molding step comprises subjecting the nonwoven web to a molding force at a temperature T_{d} such that T_{g}<T_{d}<Tₘ. Put differently, the molding temperature is selected between the glass transition temperature T_{g} and the melt temperature Tₘ of the polymer, so that the filaments are softened during stretching, and the web can be uniformly molded. The molding step results in the formation of a three-dimensional structure.

It will be understood that, prior to the molding step, the nonwoven web has a substantially planar form. It will be understood also, that the molding step involves an increase of the surface area of the web. In an embodiment the molding step results in an increase in the surface area of the web in the range of from 200% to 800%, preferably from 250% to 600%, in the molded area.

It will be understood that this increase in surface area of the web requires a corresponding elongation of the filaments in the molded area instead of breaking the filaments. This is why it is important to preserve the elongation properties of the filaments during the spinning and bonding processes. In addition, the three-dimensional structure must substantially retain its shape when the molding force ceases to be applied. This is why shrinkage of the filaments as a result of the heat treatment, which is unavoidably part of the molding step, should be kept to a minimum. Polymer selection is also critical to providing a fabric having the requisite shape retention properties.

After the molding step the three-dimensional structure is cooled to ambient temperature. This can be accomplished by exposing the structure to ambient conditions. The cooling can be accelerated, if desired, for example by blowing chilled air across the structure.

In an embodiment the three-dimensional structure is a filter. This embodiment will be illustrated with reference to a three-dimensional filter, such as a tub-shaped filter, for use in a single-serve beverage capsule. It will be understood that the process of the invention can be used in the manufacture of shaped filters of any kind.

### DESCRIPTION OF ILLUSTRATIVE EMBODIMENTS/EXAMPLES

The following is a description of certain embodiments of the invention, given by way of example only, and with reference to the drawings.

The process of the invention can be used in the manufacture of shaped filters for use in single-serve beverage capsules, for example capsules for brewing single-serve portions of coffee, tea or soup.

The process comprises providing a non-woven web of a thermoplastic polymer. For use in a beverage capsule the polymer should be food contact safe, and approved for exposure to brewing temperatures up to 100° C. for the defined brewing period, normally less than 2 min. Multi-component filaments, for example of the islands-in-the-sea type, have been found to be particularly suitable. In an embodiment the “islands” are made of a polyester material, such as polybutylene terephtalate (“PBT”) and PET and Nylon, and the “sea” areas of a polyolefin, such as polypropylene (“PP”), polyethylene (“PE”), in particular Linear Low Density Density Polyethylene (“LLDPE”). Core-sheath type filaments are also suitable for use in this invention. For instance, the “core” can be made of polyester, such as polylactic acid (“PLA”), polyethylene terephtalate (“PET”) or polybutylene terephtalate (“PBT”); and the “sheath” can be made of PE, PP, or a PE/PP co-polymer.

The nonwoven web can have a basis weight in the range of 30 to 200 g/m², preferably 50 to 150 g/m². The web is made of filaments having a mean diameter in the range of from 5 to 50 μm. The web suitably has air permeability (as measured by the method ASTM D737) of 100 to 500 cubic feet per minute (cfm).

The molding process is schematically depicted in FIG. 1. FIG. 1A shows a nonwoven web 10, which is clamped in ring 11. Molding mandrel 12 is moved towards web 10 in the direction of arrow 13. Molding mandrel 12 is kept at a temperature between 100 and 200° C., depending upon the chemical nature of the nonwoven fabric.

FIG. 1B shows molding mandrel 12 in its molding position.

FIG. 1C shows molding mandrel 12 as it is being moved away from web 10, in the direction of arrow 14.

FIG. 1D shows the three-dimensional filter 15, resulting from the molding action.

The dwell time of a mandrel contacting with nonwoven web normally is not more than 10 sec, preferably not more than 5 sec with the consideration of machine throughput.

The increase in surface area resulting from the molding step can be calculated as follows. The original surface area is that of a circle having a radius of 22 mm. The original surface area is π·(22)²=1,520 mm². The surface area of the molded three-dimensional filter can be approximated of that of a cylinder of having a length of 34 mm and an average diameter of 39 mm, plus a circle having a diameter of 34 mm, or (π×39×34)+π(17)²=4,164+907=5,071. The increase is 5,071/1,520×100%=334%.

The one-dimensional elongation is approximately (34+34+34)/44×100%=232%. During the molding process the mean diameter of the pores in the web increases by no more than 232%. The desired result is a mean pore diameter in the range of from 10 to 30 μm. To reach this endpoint the mean pore diameter of the web before molding should be in the range of from 4.3 to 13 μm.

The surface area increase during the molding process should be the result of filament elongation, with as little as possible disruption of filament-filament bonds and filament breakage.

FIG. 2 depicts examples of bonding patterns. In general, it is desirable to use a bonding pattern that maximizes the bonding strength while limiting the bonding area. The bonding patterns of FIGS. 2A and 2E can be considered based on geometry. The bonding patterns of FIGS. 2B (honeycomb), 2C and 2D (snowflakes) and 2F (spider's web) are based on patterns found in nature, providing elegant solutions to the quest for maximizing strength while limiting the occupied area.

Other examples in found in nature provide additional sources of inspiration for bonding patterns, such as the vascular patterns of various leaves; fish scale patterns; palm tree bark patterns, and the like.

Many modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A process for forming a three-dimensional structure from a non-woven synthetic polymer filament web, said synthetic polymer having a glass temperature T_{g} and a melt temperature Tₘ, said process comprising the steps of:
a. providing a non-woven web of synthetic polymer filaments having a web area and a bonding area such that the bonding area is from 2% to 50% of the web area; and a web tensile strength in the range of 5 to 120 N/cm;
b. subjecting the non-woven web to a molding force at a temperature T_{d}, such that T_{g}<T_{d}<Tₘ to form a three-dimensional structure;
c. cooling the three-dimensional structure to ambient temperature.

2. The process of claim 1 wherein the web has a bond area in the range of from 2% to 30% of the web area.

3. The process of claim 2 wherein the web has a bonded area in the range of from 3% to 15% of the web area.

4. The process of claim 1 wherein the non-woven web of synthetic polymer filaments has been obtained by a melt-blown process.

5. The process of claim 1 wherein the web has a tensile strength in the range from 10 to 100 N/cm.

6. The process of claim 1 wherein step b. results in an increase in surface area of the web in the range of from 200% to 800%.

7. The process of claim 6 wherein the increase in surface area is in the range of from 250% to 600%.

8. The process of claim 1 wherein the three-dimensional structure is a filter.

9. The process of claim 8 wherein the polymer filaments have a mean diameter in the range of from 5 to 50 μm.

10. The process of claim 8 wherein the filter comprises pores having a mean diameter in the range of from 10 to 30 μm.

11. The process of claim 7 wherein the filter comprises pores, said pores having resulting in an air permeability of from 100 to 1000 cfm.

12. A non-woven polymer filament web for use in the process of claim 1.

13. The non-woven web of claim 12 wherein the polymer is selected from polyolefins, polyesters, Nylon and combinations thereof.

14. The nonwoven web of claim 13 wherein the polymer is a polyester.

15. The nonwoven web of claim 14 wherein the polymer is polyethylene theraphtalate, polybutylene terephthalate, or polylactic acid.

16. The non-woven web of claim 12 wherein the polymer is a food grade polymer.

17. The nonwoven web of claim 12 made by a spunbond process.

18. The nonwoven web of claim 12 wherein the bonded area is formed by selective-area bonding.

19. The non-woven web of claim 12 wherein the bonded area is formed by thermal bonding, ultrasonic bonding, or mechanical bonding.

20. The non-woven web of claim 19 wherein the bonded area is formed by ultrasonic bonding.

21. The non-woven web of claim 18 wherein the selective-area bonding forms a symmetric bonding pattern.

22. The non-woven web of claim 21 wherein the symmetric bonding pattern is selected from the group consisting of dot patterns; honeycomb patterns; star patterns; star+dot patterns; diamond patterns; spider patterns; and combinations thereof.

23. A three-dimensional structure formed by the process of claim 1.

24. The tree-dimensional structure of claim 23 which is a tub shaped filter.

25. A single serve beverage capsule comprising the tub shaped filter of claim 24.
